(19) United States
(12) Patent Application Publication
(10) Pub. No.: US 2026/0367052 A1
(43) Pub. Date: Nov. 19, 2026

(54) Titration System and Method

(71) Applicants: Yale University, New Haven, CT (US); University of New Hampshire, Durham, NH (US)

(72) Inventors: Peter Raymond, Branford, CT (US); James Nikkel, North Haven, CT (US); Christopher William Hunt, Dover, NH (US)

(73) Assignees: Yale University, New Haven, CT (US); University of New Hampshire, Durham, NH (US)

(21) Appl. No.: 19/130,007

(22) PCT Filed: Nov. 17, 2023
(86) PCT No.: PCT/US2023/080335

§ 371 Date: May 14, 2025

Related U.S. Application Data
(60) Provisional application No. 63/426,174, filed on Nov. 17, 2022.

(51) Int. Cl. G01N 31/16

(52) U.S. Cl. CPC G01N 31/16

(57) ABSTRACT

Systems and methods for titration of samples are provided that operate in an automatic manner, ie., without a need for user intervention. The disclosed titration systems/methods provide reliable measurements in various environments, including challenging/robust environments, and may include analytic tools for measurement processing and analysis. The systems and methods provided may also be used to automatically and continuously characterize and monitor the acid neutralizing capacity (ANC) and carbonate levels of an aqueous solution.

### CROSS-REFERENCE TO RELATED APPLICATION

The present application claims priority benefit to a U.S. provisional patent application entitled “Titration System and Method,” which was filed on Nov. 17, 2022 and assigned Ser. No. 63/426,174. The entire content of the foregoing provisional application is incorporated herein by reference.

### BACKGROUND

### 1. Technical Field

The present disclosure is directed to systems and methods for titration of samples, including titration systems and methods that operate in an automatic and/or continuous manner. The disclosed titration systems/methods provide reliable analyte measurements in various environments, including challenging/robust environments, and may include analytic tools for measurement processing and analysis. The present disclosure has particular applicability in monitoring carbon sequestration systems and other systems designed to reduce and/or manage carbon emission levels and ocean acidification.

### 2. Background Art

Alkalinity and acid neutralizing capacity (ANC) are master variables of aquatic chemistry. They measure the buffering capacity, or ability of a water body to resist large pH changes with introductions of acids. Both are measured through the process of titration, where acid is added and a change in pH is recorded. Conventional titration systems generally require user interactions to perform analyte measurement, e.g., to manage sample introduction to the titration measurement system, metered introduction of the titrant to achieve a desired pH adjustment, and subsequent discharge of the titrated sample from the system and associated cleaning of the system prior to initiating further sample testing. The requirement for user interaction and control limits the utility of conventional titration systems.

A further limitation on the general utility and applicability of conventional titration systems involves the components and measurement modality associated with such systems as well as the relatively high cost associated with such systems. Specifically, titration measurements that are dependent on the accuracy and control of metering equipment to establish sample properties are necessarily subject to maintenance issues, particularly when subjected to potentially severe environmental conditions, e.g., in the field. Additionally, conventional titration systems are frequently assembled from components that fail to offer a robustness that allows reliable use in a range of conditions and environments.

Thus, although titration systems are widely available and well understood in terms of chemical and operational properties, a need remains for titration systems and associated methods that offer reliable and automated (or semi-automated) analytical operations, and that can operate reliably in a range of conditions and environments, including field operations. These and other needs are satisfied by the titration systems/methods disclosed herein.

### SUMMARY

The present disclosure provides a fully automated titration system that is inexpensive and operates using an electronic pH sensor, sample and titrant introduction pumps and load cells or other means to measure the sample size and titrant dose size. The disclosed titration system may be advantageously operated in various settings, including in the field or industrial settings, and is adapted for continuous operation to generate analyte measurements in an effective and low cost manner.

The disclosed automated system uses microcontrollers to combine data from load cells (to measure sample size and titrant doses) or other measurement means, a pH sensor, and a thermometer to calculate the total alkalinity or ANC of a sample. The disclosed system further includes a set of electronically controlled valves, pumps, and sensors that function to automatically rinse, fill and empty the system to facilitate sequential sample measurements.

While the disclosed system/method has particular utility in continuously measuring/monitoring ANC of a water source, the disclosed system/method is not limited to such applications, but instead may be used more generally for automatic titrations in a full range of applications.

The disclosed system/method offers a host of benefits and advantages relative to conventional titration systems, including:
The disclosed systems/methods may be implemented with low power requirements and robust components to facilitate reliable deployment in a wide range of applications and environments, including applications in the field and industrial settings.
The disclosed systems/methods may be implemented for automated use, including fully automated use, thereby eliminating or substantially reducing the need for user interaction with and/or control of sample collection and/or titration operations. For example, when seeking to sample storm events, complete tidal cycles, diurnal variability or real time aquaculture/wastewater water quality, conventional systems generally require someone to be physically present to interact with and operate the system, e.g., for 12+ hours. Due to inherent sampling/testing challenges of existing systems, valuable data is not collected for review/analysis.
In exemplary embodiments, the disclosed systems/methods use weight, in whole or in part, to determine sample size and titrant dose. The titrant dose is generally delivered using a metering pump, thereby providing a second/independent mode for titrant dose measurement. The combination of the two measurement methods as it relates to titrant dosage can reduce uncertainties and increase confidence/reliability in dosing during titration.
The disclosed systems/methods may be implemented such that data from titration operations is stored locally and also uploaded in real-time to a computer server using a WiFi, cellular, or satellite network connection. Users can observe and analyze the data without a need to interact with and/or be in proximity to the titration system itself.
The disclosed systems/methods may also be controlled from a remote location using a WiFi, cellular, or satellite network connection. This can include, but is not limited to: starting and stopping the device, changing measurement parameters, or changing the sample source.
By measuring pH and performing a titration, the disclosed systems/methods can be used to completely constrain the carbonate system (i.e., TCO₂, CO₂, HCO₃⁻, OH⁻, CO₃⁻², H⁺).

Additional features, functions and benefits of the disclosed systems and methods will be apparent from the detailed description which follows, particularly when read in conjunction with the accompanying figures.

### BRIEF DESCRIPTION OF THE FIGURES

To assist those of skill in the art in making and using the disclosed systems and methods, reference is made to the accompanying figures, wherein:

FIG. 1 is a partially exploded schematic depiction of an exemplary titration system according to the present disclosure;

FIG. 2 is an assembled schematic depiction of the exemplary titration system according to FIG. 1;

FIG. 3 is a perspective view of the exemplary titration system according to FIG. 1 and FIG. 2 in association with a controller;

FIG. 4 is a flowchart setting forth operative steps in connection with an exemplary titration methodology according to the present disclosure;

FIG. 5 is a partially exploded schematic depiction of a further exemplary titration system according to the present disclosure;

FIG. 6 is a partially exploded schematic depiction of an additional exemplary titration system according to the present disclosure; and

FIG. 7 is a plot of pH vs. added titrant for an exemplary implementation of the disclosed titration system.

### DESCRIPTION OF EXEMPLARY EMBODIMENT(S)

The present disclosure addresses the aforementioned drawbacks by providing a titration system and method for determining the concentration of an analyte in a sample. The titration system may be used to monitor the concentration of an analyte within a clean-in-place system. The titration system may, for example, use a load cell to measure the mass of a mixture during titration. The load cell may provide less systematic error and higher precision when compared with previous volumetric titration methods. The titration system may also include a self-cleaning feature that reduces contamination within the titration system, and allows for reproducible measurements between titrations.

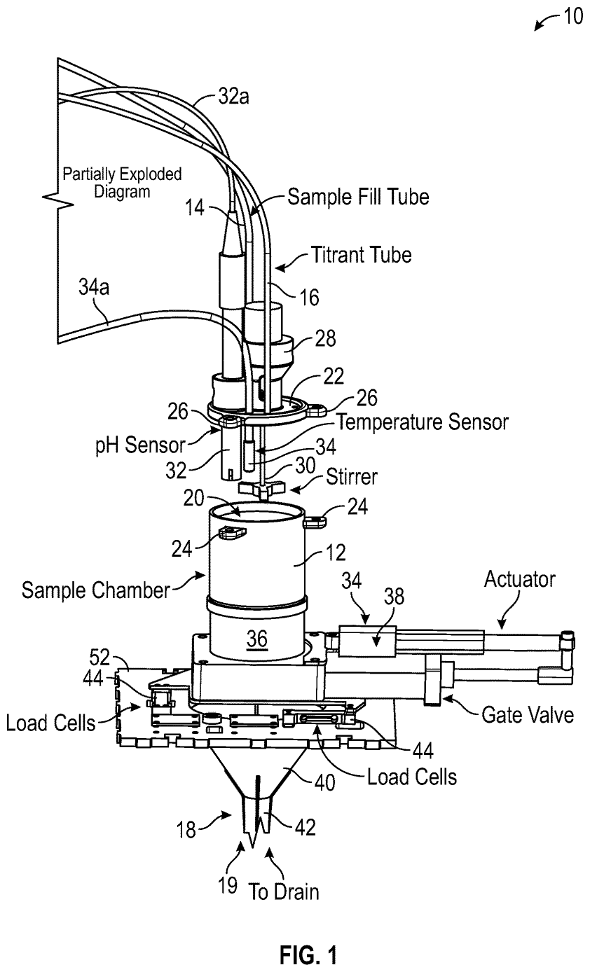

With reference to FIGS. 1-3, an exemplary titration system 10 is schematically depicted according to the present disclosure. Titration system 10 includes a sample chamber 12 that is in fluid communication with a sample supply line 14, a titrate supply line 16 and an outlet chamber 18 that discharges into a drain 19. The drain 19 typically communicates with an appropriate discharge path, e.g., a piping system designed to appropriately discharge fluids to a fluid handling system or a discharge into the environment, as appropriate.

Sample supply line 14 is in fluid communication with a source of sample fluid, e.g., a fluid line associated with a processing system, a fluid line associated with a fluid handling system, or a fluid body such as a lake, pond, stream, or marsh. The sample supply line 14 typically receives pumped fluid that is directed into the sample chamber 12. Various pumping systems may be employed to supply fluid to the sample supply line 14, as will be readily apparent to persons skilled in the art. Alternatively, fluid may be fed to the sample supply line 14 based on gravimetric feed. The volumetric feed to the sample supply line 14 may be measured, but such volumetric measurement is not necessary in view of the load cells discussed below.

The titrate supply line 16 is in fluid communication with a source of titration fluid/titrate. A metering pump (not pictured) is generally employed to deliver titrate to the sample chamber 12 by way of the titrate supply line 14. However, a metering pump and associated volumetric measurement is not required according to the present disclosure in view of the load cells discussed below. Volumetric measurement of the titrant delivered to the sample chamber 12 is advantageous according to exemplary embodiments/implementations of the disclosed system/method because such volumetric measurement(s) provide a beneficial cross-check/verification of the load cell measurements discussed below. In embodiments and implementations that include volumetric measurement of titrant supply to the sample chamber 12, the volumetric measurement(s) are generally delivered to the control system (discussed below) for inclusion in analytic processing.

The titrate supply line 16 is generally positioned so as to deliver titrant in a centered fashion relative to the inner wall of the sample chamber 12, i.e., at or in close proximity to the central axis of sample chamber 12. Centered delivery of titrant to the sample chamber 12 is desirable so as to avoid direct contact of the titrant with the inner wall of the sample chamber 12, which could negatively impact effective mixing of the titrant/sample within the sample chamber 12 leading to potentially inaccurate analyte measurement. In addition, direct contact of the titrant with the inner wall of the sample chamber 12 could make cleaning of the sample chamber 12 between analyte measurements more challenging and potentially less effective.

The titrant may take various forms, depending on the sample to be measured. For example, the titrant may include sodium thiosulfate, an acid, a base, sodium lauryl sulfate or copper sulfate. Exemplary acids include hydrochloric acid, sulfuric acid, phosphoric acid and mixtures thereof. An exemplary base is sodium hydroxide.

Sample chamber 12 is schematically depicted as a cylinder, but alternative geometries may be employed (e.g., square, rectangular, elliptical, hexagonal, etc.), as will be apparent to persons skilled in the art. Sample chamber 12 defines an open upper end 20 that is adapted to receive and engage with a lid or closure structure 22. Cooperative flanges 24, 26 may extend outwardly relative to the sample chamber 12 and the lid 22, respectively, to facilitate mounting and engagement as between the sample chamber 12 and lid 22. Alternative mounting/engagement structures/systems may be employed, e.g., a screw thread, may be employed, as will be apparent to persons skilled in the art.

Lid/closure structure 22 supports a series of operative elements associated with the titration system 10 of the present disclosure. Thus, lid 22 supports (i) a motor 28 that cooperates with and rotatably drives a stirrer 30 positioned within the sample chamber 12, (ii) a pH sensor 32 that extends into the sample chamber 12, and (iii) a temperature sensor 34 that also extends into the sample chamber 12. The motor/stirrer subassembly is generally conventional in design and operation, as is known in the art. For example, a brushless DC motor with multi-speed control operable in ranges from 10-1500 rpm may be employed. Similarly, the pH sensor 32 is generally selected from among conventional pH sensor systems, i.e., a sensor that measures the activity of hydrogen ions in the sample as compared to pure water, subject to form factor limitations associated with the disclosed titration system 10. Further, temperature sensor 34 may take any conventional form.

With further reference to sample chamber 12, the inner wall thereof is typically inert and smooth in design, thereby reducing the potential for “impurities” to be retained by the inner wall from sample-to-sample. In exemplary embodiments of the present disclosure, the inner wall of sample chamber (and potentially the underside of lid 22) may be coated with a hydrophobic coating (e.g., silica-based coatings and/or fluoropolymer/fluorinated silane coatings) to further reduce the potential for impurity retention on the inner wall of the sample chamber 12 from sample-to-sample.

In exemplary embodiments of the present disclosure, sample chamber 12 rests upon and is in fluid communication with a valve subassembly 34, e.g., a gate valve subassembly. Valve subassembly 34 includes a chamber 36 that is configured and dimensioned to cooperate with sample chamber 12 (e.g., a sample chamber 12 that rests thereabove and is in fluid communication therewith), an actuator 38 and a valve mechanism, e.g., a gate valve (not pictured), positioned within chamber 36. The actuator 38 functions to move the gate valve from a closed position (in which position the sample/titrant mixture is retained within sample chamber 12) and an open position (in which position the sample/titrant mixture is permitted to flow downward past the gate valve and through chamber 36 so as to reach drain 19).

Although valve subassembly 34 may be implemented in various forms, preferred implementations of the disclosed valve subassembly 34 include gate valve systems that are used in industrial environments and are designed to withstand challenging environmental conditions, e.g., gate valve systems used in sewage lines. Of note, exemplary gate valve systems for use according to the present disclosure are selected/implemented such that all or substantially all of the cross-sectional area of chamber 36 is available/unobstructed to permit downward fluid flow from sample chamber 12 when the gate valve is moved to the “open” position by actuator 38. In this way, full and efficient evacuation of the sample chamber 12 may be achieved, e.g., when transitioning from a first sample to a second sample measurement. Moreover, by providing an unencumbered passage from the sample chamber 12 into and through chamber 36, the potential for retention of residual “impurities” within sample chamber 12 is reduced from sample-to-sample.

As an alternative to a gate valve, a ball valve could also be employed which would have the same open flow characteristics. In this case, a rotary rather than a linear actuator would be used to open and close the valve. From a form factor standpoint, a gate valve generally requires more space in the horizontal plane, whereas a ball valve of equivalent flow generally requires more space vertically. Space considerations may be one factor influencing selection of a desired valving option for a particular application.

The flow path from chamber 36 to drain 19 may take various forms. As shown in FIGS. 1-3, an exemplary flow path takes the form of a conical flow transition 40 that directs the discharged fluid from sample chamber 12 to a pipe 42 of reduced diameter relative to the diameter of sample chamber 12 and chamber 36. Thus, for example, flow transition 40 may take alternative geometric forms, such as a trapezoidal geometry. Like the sample chamber, the inner walls of chamber 36 and flow transition 40 may be coated with a hydrophobic coating (e.g., silica-based coatings and/or fluoropolymer/fluorinated silane coatings) to further reduce the potential for impurity retention thereon.

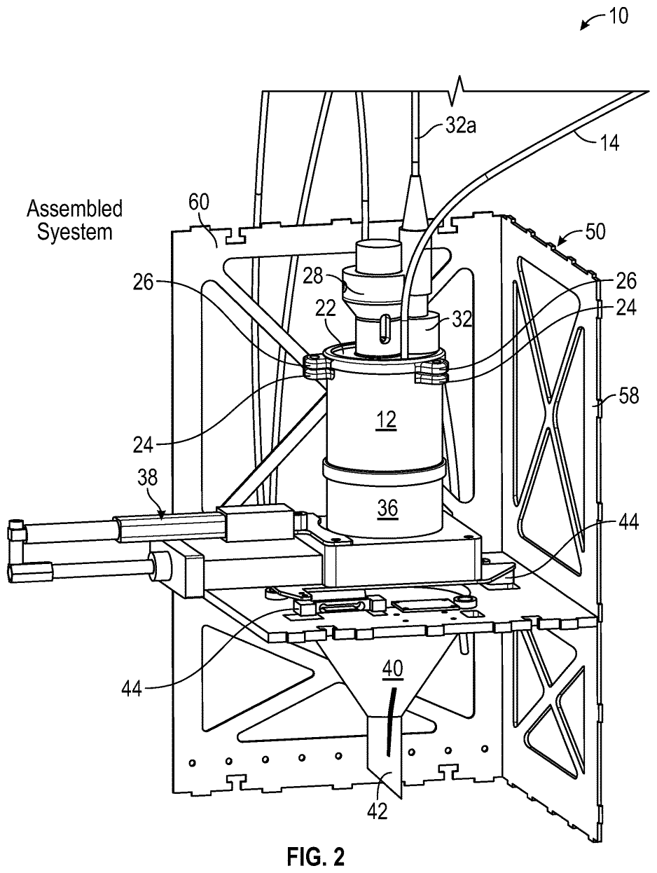

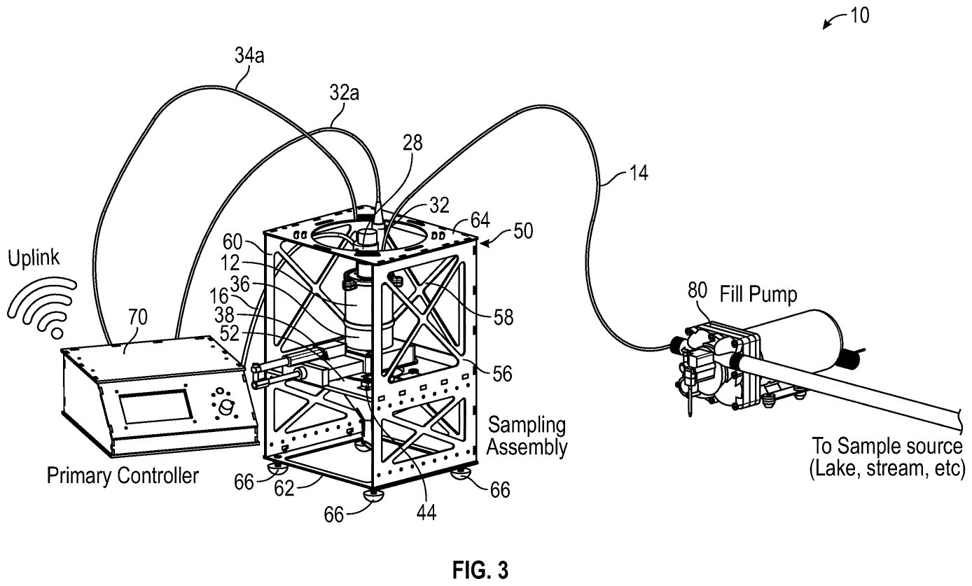

With reference to FIGS. 2 and 3, titration system 10 may be associated with and supported by a support assembly 50. Support assembly 50 generally defines a base or shelf 52 upon which titration components are positioned. Base 52 typically includes an opening that permits discharge of fluids from titration system 10 to drain 19. The opening may be configured and dimensioned to accommodate positioning of a portion of chamber 36 and/or flow transition therewithin. Support assembly 50 may further include one or more side faces 56, 58, 60, a lower face 62 and an upper face 64. Support assembly 50 may include support members/pads 66 mounted with respect to lower face 62. Support members 66 may allow for adjustable height or to adjust the level of the full assembly. The overall design and support assembly 50 is selected so as to provide structural integrity and stability to base 52 so that it can effectively support titration system 10, while simultaneously accommodating the introduction and discharge of fluids associated with titration operations and mounting/de-mounting of requisite components for use in titration operations, e.g., the motor 28 and stirrer 30, pH sensor 32 and temperature sensor 34. Thus, support assembly 50 may take various forms, including forms that include additional features/functions (such as additional shelves for support of other equipment and/or supplies, and may be substantially enclosed (e.g., taking the form of a cabinet).

With specific reference to base 52, it is noted that base 52 generally provides a substantially horizontal surface upon which titration components of titration system 10 are positioned. Importantly, load cell(s) 44 rest upon base 52 and support titration components of titration system 10, thereby measuring the load/weight of the titration components of titration system 10 at point(s) in time. In exemplary embodiments of the present disclosure, chamber 36 rests upon and is supported by load cell(s) 44. In alternative embodiments, the sample chamber 12 (or flange extensions associated with sample chamber 12) rests upon and is supported by load cell(s) 44. Regardless of the specific form factor, titration system 10 is configured and dimensioned such that load cell(s) 44 are positioned so as to measure the load exerted by sample chamber 12 and, more specifically, changes in load associated with chamber 12, e.g., as titrant is introduced to sample chamber 12.

A fill pump 80 typically communicates with sample fill tube 14 to supply sample to sample chamber 14. Operation of fill pump 80 is typically controlled by processor 70. As shown in FIG. 3, fill pump 80 may be in fluid communication with various sample sources, e.g., lake, stream, pond, marsh, industrial fluid retention system, etc.

In the exemplary embodiment of FIGS. 1-3, three load cells 44 are positioned on base 52 for measuring the load associated with sample chamber 12. Lesser or greater numbers of load cells 44 may be employed. However, it is preferred to include a plurality of load cells 44 so as to obtain multiple measurements of the load to improve accuracy and reliability of the measurement results. According to exemplary embodiments, simultaneous readings from the respective load cells 44 are transmitted/communicated to a processor 70 that may average the readings to arrive at a single load cell measurement for analytic/operational purposes. Of note, processor 70 may be on site with the other components of titration system 10, or may be remotely located relative to the operational components of titration system 10, such that measurement results are transmitted/communicated to the remote processing system/location, e.g., using conventional communication protocols (e.g., WiFi, BlueTooth and the like). As schematically depicted in FIG. 3, the pH sensor 32 and temperature sensor 34 may be hard-wired to processor 70 (see cables 32a and 34a).

Processing functionality (as schematically depicted by processor 70) may be available in multiple physical locations and may be delivered by distinct/independent processing units. Processing functionality may also be distributed, such that portions of the analytic/operational processing may be undertaken in distinct physical locations and/or based on distinct/independent processing units, with the analytic/operational processing being performed in a collaborative fashion. Similarly, data storage may be associated with a processing system located on site with titration system 10, remote from titration system 10, or in both/multiple locations.

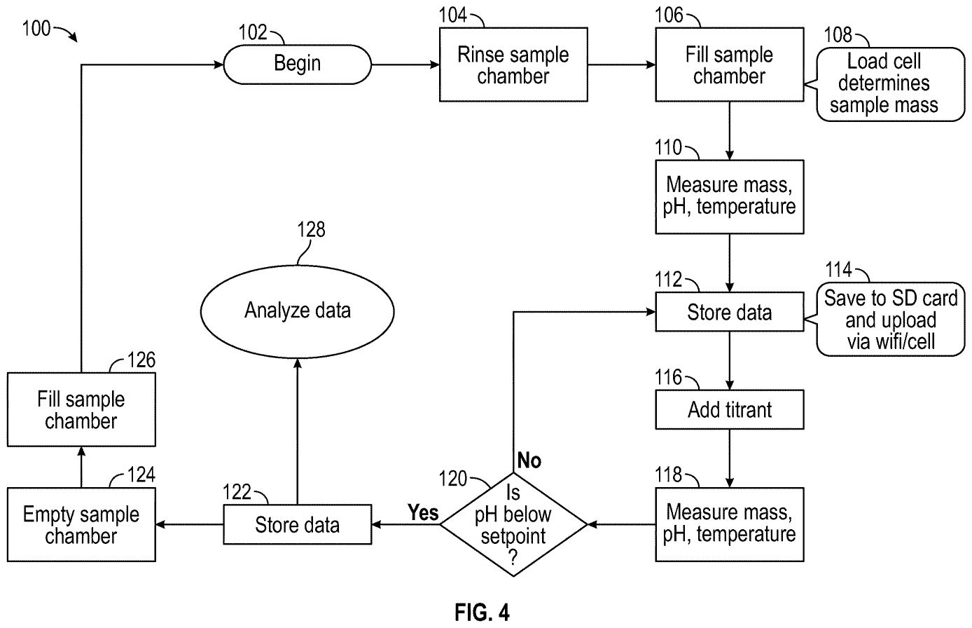

With reference to FIG. 4, a flowchart 100 is provided for an exemplary measurement method according to the present disclosure. The present disclosure is not limited by or to the measurement method depicted in FIG. 4. At step 102, the process begins. Initially, the sample chamber is rinsed with a rinsing solution (as necessary depending on prior use of titration system 10) at step 104. The rinsing step generally entails repeated rinsing cycles, e.g., three rinsing cycles, to maximize the removal of impurities from titration system 10 before initiating a sample measurement regimen. Of note, the rinsing cycles and all other operations associated with titration system 10 are generally controlled by conventional programmable microcontroller(s), as are known in the art. Thus, the programmable microcontroller is typically programmed to operate according to flowchart 100, including predetermined rinsing cycles of preset volume and preset duration.

Typically, once operation of the programmed steps on the microcontroller(s) is initiated, the operative steps depicted in flowchart 100 advantageously proceed in an automated fashion, i.e., without a need for user intervention. Thus, multiple samples may be sequentially tested in an automated fashion, e.g., based on a predetermined sampling frequency, thereby allowing fluid conditions to be monitored over the course of time.

At the conclusion of the rinsing step 104, a sample is introduced to sample chamber 12 in step 106. As noted in box 108, the load cell(s) associated with titration system 10 determine the sample mass introduced to sample chamber 12. The volume of the sample may be controlled in various ways according to the present disclosure, e.g., by pumping the sample into the sample chamber 12 using a metering pump that operates for a predetermined time, or by monitoring the mass measured by the load cell(s) as fluid sample is introduced to sample chamber 12 and discontinuing fluid sample feed once a predetermined mass is reached (e.g., by closing a feed valve or shutting off a sample feed pump). Of note, when the fluid sample is introduced to sample chamber 12, gate valve subassembly 34 is in a “closed” position.

As noted in step 110, the disclosed system advantageously typically measures the mass, pH and temperature of the sample introduced to sample chamber 12 before initiating the titration step. The results of such measurements are stored for analytic use (step 112). As noted in box 114, the data may be stored in various ways, e.g., on a “secure digital” or SD card in close association to titration system 10 (e.g., an SD card associated with processor 70) and such data may be uploaded to a remote server, e.g., using WiFi or cellular technology.

At step 116, titrant is added to the sample chamber 12 and mixed with the sample using the motor/stirrer 28/30 subassembly. The titrant may be introduced with a metering pump, and the volume introduced by the metering pump may be also be stored with the other data collected at step 112. Alternatively, the level of titrant addition may be determined based on mass change as measured by load cell(s) 44. Thus, as noted at step 118, after titration introduction commences, additional measurements are undertaken by the load cell(s) 44, pH sensor 32 and (optionally) temperature sensor 34 to capture the mass, pH and (optionally) temperature of the sample+titrant in sample chamber 12.

As noted in step 120, if the pH remains below a predetermined setpoint level, the measured pH is stored (repeat of step 112), additional titrant is introduced to the sample chamber 12, (repeat of step 116) and a re-measurement of mass, pH and (optionally) temperature is undertaken (repeat of step 118). The newly measured pH is again compared to the predetermined pH setpoint and the process is repeated until the pH falls below the predetermined pH setpoint. Thus, the instrument can be used to perform inflection point, gran, or fixed endpoint titrations.

Once sufficient titrant is added to the sample to reduce the pH to the requisite setpoint level, the final data is stored (step 122) and sample chamber 12 is emptied by opening the gate valve 38 to allow discharge of the sample/titrant solution to the drain 18 (step 124). Titration system 10 is now ready for initiation of a new sample testing regimen and, as noted in step 126, sample chamber 12 is generally filled with fluid to maintain the pH sensor immersed between measurements.

Step 128 reflects the fact that the data captured according to the data collection steps included in flowchart 100 and the associated titration method are subject to analysis. Various analytical tools and techniques may be employed to evaluate the data collected by the disclosed titration system 10. In particular, the level of titration required to adjust the pH of the sample and the temperature at which such titration operations occurred provide valuable information concerning the fluid sample, and may be used, for example, to monitor water conditions in the field associated with streams, rivers, marshes, lakes and other waterways. The automated, reliable and robust operations of the disclosed titration system and associated method offer substantial benefits as compared to conventional titration systems/methods.

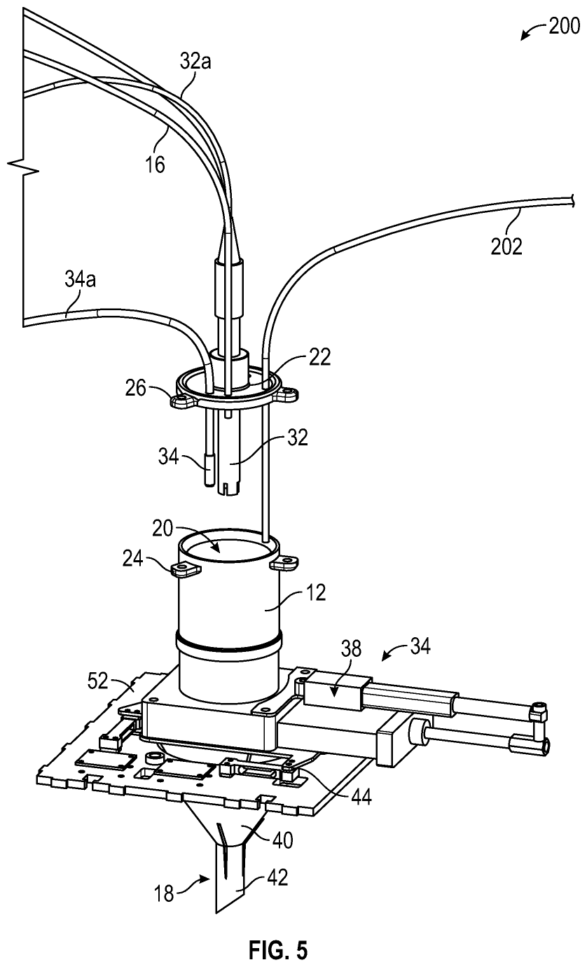

With reference to FIG. 5, an alternative titration system 200 is schematically depicted. Titration system 200 includes many structures/elements that correspond to those described with reference to titration system 10, as schematically depicted in FIGS. 1-3, and, for those structures/elements, the same reference numbers are utilized. The functionalities of the structures/elements associated with titration system 200 that are also associated with titration system 10 are described above with reference to titration system 10.

With further reference to FIG. 5, titration system 200 includes an air supply line 202 that allows the introduction of air to sample chamber 12. The introduced air causes turbulence, e.g., bubbling, within sample chamber, thereby effectuating sufficient agitations and/or stirring of the sample and titrant mixture in the sample chamber to ensure a full chemical reaction, thereby obviating the need for stirrer 30 (as described with reference to titration system 10). Of note, the introduction of air (or other inert gas) to sample chamber 12 to promote mixing of sample contents is an alternative to the stirring modality described with reference to titration system 10. However, the present disclosure is not limited by or to a stirring modality or a bubbling modality. Indeed, any mixing modality may be implemented without departing from the spirit or scope of the present disclosure, e.g., a combination of mixing and bubbling modalities, stirring with a paddle driven by a motor, provision of an air pump and tubing to bubble air through the sample chamber, or provision of a liquid pump to circulate the liquid in the sample chamber.

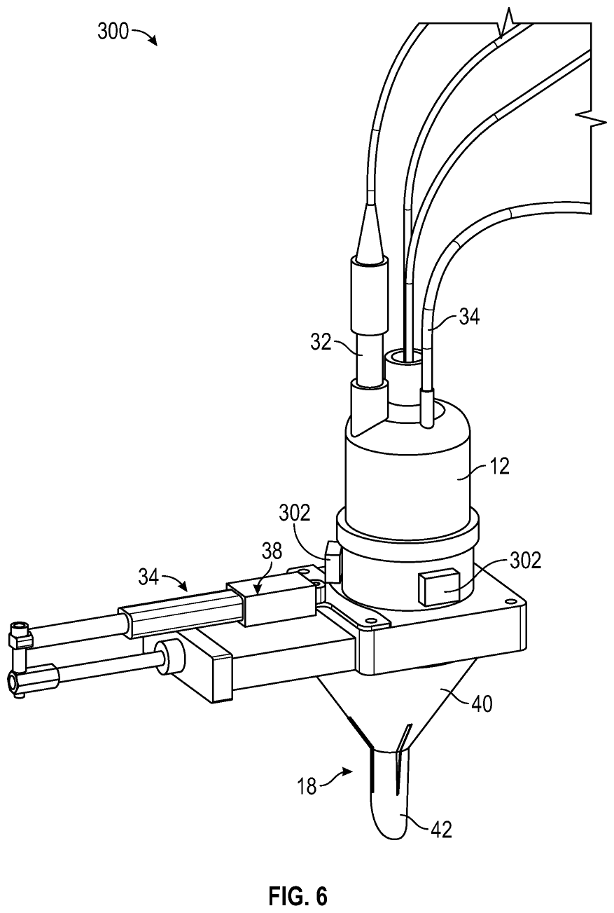

Turning to FIG. 6, a further alternative titration system 300 is schematically depicted. As with titration system 200, titration system 300 includes many structures/elements that correspond to those described with reference to titration system 10, as schematically depicted in FIGS. 1-3, and, for those structures/elements, the same reference numbers are utilized. The functionalities of the structures/elements associated with titration system 300 that are also associated with titration system 10 are described above with reference to titration system 10.

Titration system 300 includes one or more pressure sensors 302 mounted with respect to sample chamber 12. Pressure sensor 302 is adapted to measure the pressure applied by the fluids contained within sample chamber 12. The measured pressure may be correlated to the volume of fluid present in—and added to—sample chamber, thereby allowing a determination of the titrant added to sample chamber. Pressure sensor 302 is an exemplary alternative to load cells 44 associated with titration system 100. However, the present disclosure is not limited by or to a load cell modality for measuring titrant added to the sample chamber over time or a pressure sensor modality for measuring titrant added to the sample chamber over time. Indeed, alternative titrant measuring modalities may be implemented without departing from the spirit or scope of the present disclosure, e.g., a light-based sensing system may be employed to measure/monitor an increased volume within the sample chamber.

The disclosed titration system may be particularly effective in automatically and continuously monitoring the carbonate system associated with an aqueous source (streams, rivers, marshes, lakes and other waterways) in actual field conditions. In particular, by continuously measuring pH and alkalinity, the disclosed titration system 10, 200, 300 in combination with controller 70 may be used to characterize the rest of the carbonate system for the aqueous source.

Carbon dioxide in the atmosphere or from alternative sources such as organic matter degradation, will naturally equilibrate with water on Earth. CO₂ rapidly equilibrates with water, at a proportion following Henry's Law:

CO_{2(g)}<->CO_{2(aq)} (Eq 1)

The amount of CO₂ that will dissolve into water is proportional to the partial pressure of the gas in the system. When more CO₂ is added to the system, more will dissolve, forming the weak acid, carbonic acid, which will reduce the pH of the water:

CO_{2(aq)}+H₂O_{(aq)} [symbol] H₂CO_{3(aq)} (Eq 2)

Depending on the chemistry of the water, the species of carbon will be portioned as carbonic acid, bicarbonate, and carbonate ion:

CO₂+H₂O [symbol] H⁺+HCO₃⁻ [symbol] 2H⁺+CO₃²⁻ (Eq 3)

These carbon species can then be related by four equations:

Carbonate ALK=[HCO₃⁻]+[2CO₃²⁻]−[H⁺] (Eq 4)

DIC=[CO₂]+[HCO₃⁻]+[CO₃²⁻] (Eq 5)

K1=[HCO₃⁻][H⁺]/[CO₂] (Eq 6)

K2=[CO₃²⁻][H⁺]/[HCO₃⁻] (Eq 7)

which, with assumptions about dissociation constants (K₁ and K₂), temperature, salinity, and pressure, can be solved if two parameters are known or measured.

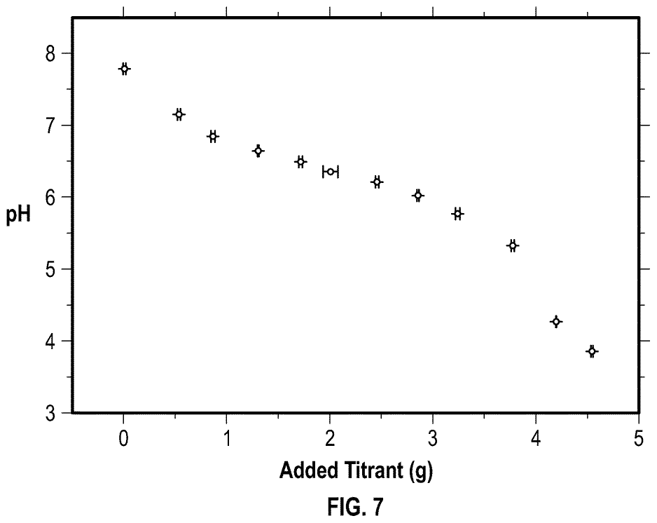

FIG. 7 provides a plot of pH vs titrant mass for a water sample taken from the mouth of the Connecticut River in June of 2023 using a titration system of the type schematically depicted in FIGS. 1-3 as titration system 10. Sample mass was 143.5 g. Error bars in FIG. 7 indicate statistical uncertainty of the measurements for each dose. This data can be fit to determine total alkalinity of the sample according to the present disclosure.

Given the nature of the measurements enabled by the disclosed systems and methods, the present disclosure has particular applicability in monitoring carbon sequestration systems and other systems designed to reduce and/or manage carbon emission levels. The automated measurement capability afforded by the disclosed systems/methods make it possible to obtain sequestration data on a continuous (or near continuous) basis, as may be desired in implementing and monitoring carbon sequestration technologies aimed at reducing climate change drivers. Similarly, the automated measurement capability afforded by the disclosed systems/methods make it possible to obtain carbon emission data on a continuous (or near continuous) basis, as may be desired in implementing and monitoring carbon emissions to facilitate climate change reduction efforts.

Although the invention has been described with reference to exemplary embodiments and implementations, the present disclosure is not limited by or to such exemplary embodiments/implementations. Rather, as persons of skill in the art will understand, the disclosed invention may be refined, modified and/or enhanced without departing from the spirit or scope of the present disclosure.

1. An automated system for pH or alkalinity measurement, comprising:
a. a sample chamber;
b. means for delivering an aqueous sample to the sample chamber;
c. a valve assembly in fluid communication with the sample chamber, the valve assembly adapted to move between a closed position and an open position to allow discharge of the aqueous sample from the sample chamber;
d. means associated with the sample chamber for measuring changes in mass within the sample chamber;
e. means for measuring pH of an aqueous sample within the sample chamber as a function of titrate addition;
f. means for measuring temperature of the aqueous sample within the sample chamber;
g. means for delivering titrant to the sample chamber, and
h. processing means programmed to (i) effect delivery of an aqueous sample to the sample chamber, (ii) control operation of the valve assembly; (iii) receive pH and temperature data from the pH measuring means and the temperature measuring means, respectively; (iv) effect delivery of titrant to the sample chamber, and (v) calculate pH of the aqueous sample based at least in part on the received pH and temperature data;
wherein operation of the sample delivery means, the valve assembly, the pH measurement means, the temperature measurement means, the titrant delivery means, and the processor are fully automated such that operation for pH calculation of the aqueous sample does not require user intervention.

2. The system of claim 1, wherein the means for measuring changes in mass comprises one or more load cells associated with the sample chamber.

3. The system of claim 2, wherein the one or more load cells comprises three load cells.

4. The system of claim 1, wherein the means for measuring changes in mass comprises one or more pressure sensors associated with the sample chamber.

5. The system of claim 1, wherein the means for measuring changes in mass comprises a light-based sensing system associated with the sample chamber.

6. The system of claim 1, wherein the means for measuring pH of an aqueous sample comprises a pH sensor that extends into the sample chamber.

7. The system of claim 1, wherein the means for measuring temperature of an aqueous sample comprises a temperature sensor that extends into the sample chamber.

8. The system of claim 1, further comprising a motor positioned in association with the sample chamber, and a stirrer that extends into the sample chamber and is driven by the motor.

9. The system of claim 8, wherein operation of the motor is controlled by the processing means, and wherein motor operation is fully automated.

10. The system of claim 1, further comprising means for delivering an inert gas to the sample chamber to effect mixing of fluids contained with the sample chamber.

11. The system of claim 1, wherein the valve assembly is selected from the group consisting of a gate valve assembly and a ball valve assembly.

12. The system of claim 1, wherein the valve assembly is associated with a chamber in fluid communication with the sample chamber.

13. (canceled)

14. The system of claim 12, wherein the chamber associated with the valve assembly is in fluid communication with a flow transition.

15. (canceled)

16. (canceled)

17. (canceled)

18. A method for automated pH or alkalinity measurement, comprising:
a. providing a titration system that includes (i) a sample chamber; (ii) means for delivering an aqueous sample to the sample chamber; (iii) a valve assembly in fluid communication with the sample chamber, the valve assembly adapted to move between a closed position and an open position to allow discharge of the aqueous sample from the sample chamber; (iv) means associated with the sample chamber for measuring changes in mass within the sample chamber; (v) means for measuring pH of an aqueous sample within the sample chamber as a function of titrate addition; (vi) means for measuring temperature of the aqueous sample within the sample chamber; (vii) means for delivering titrant to the sample chamber, and (viii) processing means programmed to effect delivery of an aqueous sample to the sample chamber, control operation of the valve assembly; receive pH and temperature data from the pH measuring means and the temperature measuring means, respectively; effect delivery of titrant to the sample chamber, and calculate pH of the aqueous sample based at least in part on the received pH and temperature data;
b. introducing a fluid sample to the sample chamber,
c. measuring the mass of the fluid sample with the means for measuring changes in mass,
d. introducing titrant to the sample chamber,
e. measuring the pH of the fluid sample after introduction of the titrant,
f. repeating the introduction of titrant and the measurement of the pH of the fluid sample after the repeated introduction of titrant until the pH measurement satisfies a predetermined threshold,
g. discharging the fluid from the sample chamber by actuating the valve assembly,
h. rinsing the sample chamber,
i. repeating steps (a) through (h) for a second fluid sample,
wherein all of the foregoing steps are undertaken in an automated manner without user intervention.

19. The method of claim 18, wherein the steps are controlled by the processing means.

20. The method of claim 18, wherein the fluid sample and the second fluid sample are introduced to the sample chamber so as not to contact a side wall of the sample chamber.

21. The method of claim 18, wherein discharge of the fluid from the sample chamber is through an opening that substantially corresponds to the cross-sectional area of the sample chamber.

22. (canceled)

23. (canceled)

24. (canceled)

25. A method for automatically and continuously characterizing and monitoring carbonate levels in an aqueous solution, comprising:
a. providing a titration system that includes (i) a sample chamber; (ii) means for delivering an aqueous sample to the sample chamber; (iii) a valve assembly in fluid communication with the sample chamber, the valve assembly adapted to move between a closed position and an open position to allow discharge of the aqueous sample from the sample chamber; (iv) means associated with the sample chamber for measuring changes in mass within the sample chamber; (v) means for measuring pH of an aqueous sample within the sample chamber as a function of titrate addition; (vi) means for measuring temperature of the aqueous sample within the sample chamber; (vii) means for delivering titrant to the sample chamber, and (viii) processing means programmed to effect delivery of an aqueous sample to the sample chamber, control operation of the valve assembly; receive pH and temperature data from the pH measuring means and the temperature measuring means, respectively; effect delivery of titrant to the sample chamber, and calculate pH of the aqueous sample based at least in part on the received pH and temperature data;
b. introducing a fluid sample to the sample chamber,
c. measuring the mass of the fluid sample with means for measuring changes in mass,
d. introducing titrant to the sample chamber,
e. measuring the pH of the fluid sample after introduction of the titrant,
f. repeating the introduction of titrant and the measurement of the pH of the fluid sample after the repeated introduction of titrant until the pH measurement satisfies a predetermined threshold,
g. discharging the fluid from the sample chamber by actuating the valve assembly,
h. rinsing the sample chamber,
i. repeating steps (a) through (h) for a second fluid sample,
j. calculating and outputting one or more of the following measurements associated with the aqueous solution: CO2 level, bicarbonate level, carbonate ion level, dissolved inorganic carbon level, and carbonate alkalinity level;
wherein all of the foregoing steps are undertaken in an automated manner without user intervention.

26. (canceled)

27. The method of claim 25, wherein the fluid sample and the second fluid sample are introduced to the sample chamber so as not to contact a side wall of the sample chamber.

28. The method of claim 25, wherein discharge of the fluid from the sample chamber is through an opening that substantially corresponds to the cross-sectional area of the sample chamber.

29. (canceled)
